(19) United States
(12) Patent Application Publication
(10) Pub. No.: US 2017/0242429 A1
(43) Pub. Date: Aug. 24, 2017

(54) SCALE FACTORS FOR GESTURE-BASED CONTROL OF AN UNMANNED AERIAL VEHICLE

(71) Applicant: Dronomy Ltd., Tel Aviv (IL)

(72) Inventors: Guy Raz, Binyamina (IL); Ori Aphek, Ramat Gan (IL)

(21) Appl. No.: 15/051,699

(22) Filed: Feb. 24, 2016

(51) Int. Cl. G05D 1/00; B64C 39/02; G06T 7/00; G06F 3/0488

(52) U.S. Cl. CPC G05D 1/0016; G06F 3/04883; B64C 39/024; G05D 1/0038; G06T 7/004

(57) ABSTRACT

Apparatus and methods are described, including apparatus for operating an unmanned aerial vehicle (UAV) that includes an imaging device. The apparatus includes a touch screen and a processor. The processor is configured to (i) receive a gesture that is performed on the touch screen with respect to an image captured by the imaging device, (ii) estimate a distance from the UAV to a given point represented in the image, (iii) compute a scale factor that is based on the estimated distance, and (iv) communicate a control signal that causes the UAV to execute a flying maneuver that is suggested by the gesture and is scaled by the scale factor. Other embodiments are also described.

### CROSS-REFERENCE TO RELATED APPLICATIONS

The present application is related to a US patent application entitled “Image processing for gesture-based control of an unmanned aerial vehicle,” attorney docket no. 1308-1003.1, filed on even date herewith, whose disclosure is incorporated herein by reference.

### FIELD OF THE INVENTION

Embodiments of the present invention relate to the control of unmanned aerial vehicles (UAVs).

### BACKGROUND

US Patent Application Publication 2014/0313332, whose disclosure is incorporated herein by reference, describes a control device including an image display unit configured to acquire, from a flying body, an image captured by an imaging device provided in the flying body and to display the image, and a flight instruction generation unit configured to generate a flight instruction for the flying body based on content of an operation performed with respect to the image captured by the imaging device and displayed by the image display unit.

Chinese Patent Application Publication CN104777847, whose disclosure is incorporated herein by reference, relates to the field of unmanned aerial vehicle target tracking and image processing, and discloses an unmanned aerial vehicle target tracking system based on machine vision and an ultra-wideband positioning technology. The target tracking system is composed of a ground control platform and an unmanned aerial vehicle tracker. The ground control platform is composed of a piece of flight control software, a data transmission module, and a video display interface. The unmanned aerial vehicle tracker is composed of a microprocessor, an FPGA, a positioning module, an airborne sensor, an intelligent vision module, a flight control module, and a data transmission module. The ground control platform sends a target tracking command. After receiving the target tracking command, the unmanned aerial vehicle tracker performs algorithm processing on an image acquired by the intelligent vision module and automatically identifies the position of a target in the image, and meanwhile, the unmanned aerial vehicle tracker reads data of the positioning module and the airborne sensor, plans a flight route according to a gesture guiding and adjusting algorithm, and sends a target moving image to the ground control platform to realize automatic visual tracking of the moving target.

U.S. Pat. No. 6,694,228, whose disclosure is incorporated herein by reference, describes a control system for a UAV that includes control translations which maximize operational employment of the UAV payload. By determining spatial references, and then using the references to transform the control stick commands, the operator treats the UAV as a point source. For control through imagery from onboard mission sensors, the transformations provide for the UAV to move itself and achieve payload orientation.

U.S. Pat. No. 8,666,661, whose disclosure is incorporated herein by reference, describes a system and method for video navigation. Motion analysis can be performed upon camera images to determine movement of a vehicle, and consequently present position of the vehicle. Feature points can be identified upon a video image. Movement of the feature points between video frames is indicative of movement of the vehicle. Video navigation can be used, for example, in those instances wherein GPS navigation is unavailable.

International PCT Application WO 2009/071755, whose disclosure is incorporated herein by reference, describes a modular drone consisting of a flying structure and image acquisition means, characterized in that said image acquisition means as well as the motorization are supported by a rigid platen connected to the flying structure by links that are detachable when the loadings between said platen and said flying structure exceed a wrenching threshold value, these links being constituted by one from among electromagnetic links and self-adhering tapes and materials. The present invention also relates to an airborne image acquisition system consisting of such a modular drone.

U.S. Pat. No. 8,903,568, whose disclosure is incorporated herein by reference, describes a remote control method and apparatus for controlling the state of a movable object and/or a load carried thereon. The remote control method comprising: receiving, via an apparatus, a state signal that corresponds to a user's position; remote-controlling the state of the a load being carried on a movable object based on the state signal; wherein the state of the load is the result of combining the movement of the load relative to the movable object and the movement of the object relative to its environment. For example, the control of the state can be achieved through the state of the apparatus itself, a user's state captured by an apparatus, a graphical interface on a screen of an apparatus, or a voice command.

US Patent Application Publication 2015/0172554, whose disclosure is incorporated herein by reference, describes a control apparatus that includes: a display control unit configured to control a display unit to display part or all of an image in a first region on a display screen displayed by the display unit, the image indicating an imaging range which an imaging apparatus can image by changing the imaging range; a change control unit configured to change a position or size of an image to be displayed in the first region by the display control unit, on the image indicating the range which an imaging apparatus can image; and an output unit configured to output an instruction to cause the imaging apparatus to image an imaging range corresponding to a range indicating an image displayed in a second region which is a part of the first region.

### SUMMARY OF THE INVENTION

There is provided, in accordance with some embodiments of the present invention, apparatus for operating an unmanned aerial vehicle (UAV) that includes an imaging device. The apparatus includes a touch screen and a processor. The processor is configured to receive a gesture that is performed on the touch screen with respect to an image captured by the imaging device, estimate a distance from the UAV to a given point represented in the image, compute a scale factor that is based on the estimated distance, and communicate a control signal that causes the UAV to execute a flying maneuver that is suggested by the gesture and is scaled by the scale factor.

In some embodiments, the image is a first image, the gesture indicates a requested change with respect to the first image, and the flying maneuver is suggested by the gesture in that, while executing the flying maneuver, subsequent images captured by the imaging device become successively more exhibitory of the requested change, relative to the first image.

In some embodiments, the scale factor is an increasing function of the estimated distance.

In some embodiments, the gesture is a swipe gesture.

In some embodiments, the gesture is a pinch gesture.

In some embodiments, the given point is represented by a portion of the image that lies between two segments of the pinch gesture.

In some embodiments, the processor is configured to estimate the distance by assuming that the given point lies on ground.

In some embodiments, the processor is configured to model the ground as a horizontal plane.

In some embodiments, the processor is configured to model the ground using a digital elevation model.

In some embodiments, the given point is represented by a portion of the image that lies along a path of the gesture.

In some embodiments, the processor is configured to scale the flying maneuver by multiplying a magnitude of the gesture by the scale factor.

In some embodiments, the processor is configured to scale the flying maneuver by multiplying a speed of the gesture by the scale factor.

In some embodiments, a distance of the flying maneuver is scaled by the scale factor.

In some embodiments, a speed of the flying maneuver is scaled by the scale factor.

There is further provided, in accordance with some embodiments of the present invention, apparatus for controlling an unmanned aerial vehicle (UAV) that includes an imaging device. The apparatus includes a touch screen and a processor. The processor is configured to (i) receive a gesture that is performed, on the touch screen, with respect to a first image acquired by the imaging device, the gesture indicating a requested change with respect to the first image, (ii) communicate, to the UAV, a first control signal that causes the UAV to begin executing a flying maneuver that is suggested by the gesture, (iii) identify a plurality of features in a subsequent image acquired by the imaging device, (iv) ascertain that respective positions of the features indicate that the flying maneuver has effected the requested change, and, (v) in response to the ascertaining, communicate, to the UAV, a subsequent control signal that causes the UAV to stop execution of the flying maneuver.

In some embodiments, the processor is configured to ascertain that the respective positions of the features indicate that the flying maneuver has effected the requested change by:

based on the respective positions of the features, identifying a configurational property of the features, and

ascertaining that the configurational property of the features indicates that the flying maneuver has effected the requested change, by comparing the configurational property to a target configurational property.

In some embodiments, the flying maneuver is suggested by the gesture in that, while executing the flying maneuver, subsequent images captured by the imaging device become successively more exhibitory of the suggested change, relative to the first image.

In some embodiments, the gesture is a swipe gesture.

In some embodiments, the gesture is a pinch gesture.

In some embodiments, the gesture is a rotation gesture.

In some embodiments,

the subsequent image is a second subsequent image, the plurality of features are a second plurality of features, and the subsequent control signal is a second subsequent control signal, and

the processor is further configured to:
identify a first plurality of features in a first subsequent image acquired by the imaging device prior to acquiring the second subsequent image, and
in response to respective positions of the first plurality of features, communicate, to the UAV, a first subsequent control signal that causes the UAV to change the execution of the flying maneuver.

In some embodiments, the first subsequent control signal causes the UAV to change a path of the flying maneuver.

In some embodiments, the first subsequent control signal causes the UAV to change a speed of the flying maneuver.

There is further provided, in accordance with some embodiments of the present invention, apparatus for controlling an unmanned aerial vehicle (UAV) that includes an imaging device. The apparatus includes a touch screen and a processor. The processor is configured to (i) receive a gesture that is performed, on the touch screen, with respect to a first image acquired by the imaging device, (ii) communicate, to the UAV, a first control signal that causes the UAV to begin executing a flying maneuver that is suggested by the gesture, at a first speed, (iii) subsequently, compute a rate of change of a position of a feature in subsequent images that are acquired by the imaging device, and, (iv) in response to the rate of change being different from a target rate of change, communicate, to the UAV, a second control signal that causes the UAV to continue executing the flying maneuver at a second speed that is different from the first speed.

In some embodiments, the gesture indicates a requested change with respect to the first image, and the flying maneuver is suggested by the gesture in that, while executing the flying maneuver, subsequent images captured by the imaging device become successively more exhibitory of the requested change, relative to the first image.

There is further provided, in accordance with some embodiments of the present invention, a method for operating an unmanned aerial vehicle (UAV) that includes an imaging device. The method includes receiving a gesture that is performed with respect to an image captured by the imaging device, estimating a distance from the UAV to a given point represented in the image, computing a scale factor that is based on the estimated distance, and communicating a control signal that causes the UAV to execute a flying maneuver that is suggested by the gesture and is scaled by the scale factor.

There is further provided, in accordance with some embodiments of the present invention, a method for controlling an unmanned aerial vehicle (UAV) that includes an imaging device. The method includes (i) receiving a gesture that is performed with respect to a first image acquired by the imaging device, the gesture indicating a requested change with respect to the first image, (ii) communicating, to the UAV, a first control signal that causes the UAV to begin executing a flying maneuver that is suggested by the gesture, (iii) identifying a plurality of features in a subsequent image acquired by the imaging device, (iv) ascertaining that respective positions of the features indicate that the flying maneuver has effected the requested change, and (v) in response to the ascertaining, communicating, to the UAV, a subsequent control signal that causes the UAV to stop execution of the flying maneuver.

There is further provided, in accordance with some embodiments of the present invention, a method for controlling an unmanned aerial vehicle (UAV) that includes an imaging device. The method includes (i) receiving a gesture that is performed with respect to a first image acquired by the imaging device, (ii) communicating, to the UAV, a first control signal that causes the UAV to begin executing a flying maneuver that is suggested by the gesture, at a first speed, (iii) subsequently, computing a rate of change of a position of a feature in subsequent images that are acquired by the imaging device, and (iv) in response to the rate of change being different from a target rate of change, communicating, to the UAV, a second control signal that causes the UAV to continue executing the flying maneuver at a second speed that is different from the first speed.

The present invention will be more fully understood from the following detailed description of embodiments thereof, taken together with the drawings, in which:

### BRIEF DESCRIPTION OF THE DRAWINGS

FIG. 1 is a schematic illustration of a method for controlling a UAV using a swipe gesture, in accordance with some embodiments of the present invention;

FIG. 2 is a schematic illustration of a method for controlling a UAV using a pinch gesture, in accordance with some embodiments of the present invention;

FIG. 3 is a flow diagram for a method for controlling a UAV, in accordance with some embodiments of the present invention;

FIGS. 4A-B are schematic illustrations of a method for controlling a UAV using a swipe gesture, in accordance with some embodiments of the present invention;

FIGS. 5A-B are schematic illustrations of a method for controlling a UAV using a rotation gesture, in accordance with some embodiments of the present invention; and

FIG. 6 is a flow diagram for a method for controlling the speed of a UAV, in accordance with some embodiments of the present invention.

### DETAILED DESCRIPTION OF EMBODIMENTS

### Overview

In embodiments of the present invention, a user controls a UAV that includes an imaging device, by performing a gesture with respect to an image captured by the imaging device. Typically, images acquired by the imaging device are displayed on a touch screen, such as that of a mobile device (e.g., a smartphone or tablet computer), and the user performs gestures with respect to the images by moving one or more fingers across the touch screen.

Each gesture indicates a requested change to the image. In response to the gesture, the processor of the mobile device causes the UAV to execute a flying maneuver that is suggested by the gesture, in that, while executing the flying maneuver, subsequent images captured by the imaging device become successively more exhibitory of the requested change. For example, the user may identify a particular target of interest in a particular image. In order to see the target with greater resolution, the user may perform a “pinch-out” gesture, by which the user moves his thumb and forefinger on the screen, in opposite directions, from a starting position that is centered on the target. Such a gesture, by convention in the art, indicates a desired “zooming in” to the target. Hence, the processor of the mobile device may cause the UAV to more closely approach the target, in order to acquire images that show the target more closely.

Other gestures that may be performed include: (i) a “pinch-in” gesture, by which the user moves his thumb and forefinger toward one another on the screen, thus indicating a desired “zooming out,” (ii) a swipe gesture, which indicates a desired panning, and (iii) a rotate gesture, which indicates a desired rotation, e.g., such as to view a particular target from a different angle.

Although the general nature of the desired flying maneuver may be readily ascertainable from the gesture that is performed, it may be challenging to derive the desired scale of the flying maneuver from the gesture. For example, although it may be readily ascertainable, from a pinch-in gesture, that the user would like the UAV to fly toward a particular point, the desired flying distance or desired flying speed might not be readily ascertainable.

Embodiments of the present invention address the above challenge, by computing an appropriate scale factor for the flying maneuver. To compute the scale factor, a processor first selects an appropriate portion of the image, and then estimates the distance from the UAV to the real-world point that is represented by the selected portion of the image. The estimated distance is then used to compute the scale factor, and the flying maneuver is then scaled by the scale factor. For example, the distance or speed of the flying maneuver may be computed by multiplying the magnitude or speed of the gesture by the scale factor.

Typically, the selection of the appropriate portion of the image is based on the assumption that the location of the gesture indicates the desired scale of the flying maneuver. Thus, for example, the selected portion of the image may be a pixel or group of pixels that lies along the path of the gesture, and/or is at the center of the gesture.

For example, in a first case, a pinch-out gesture may be performed over a first portion of the image. In response to the gesture, the processor may first estimate (using techniques described hereinbelow) that the first portion of the image represents a real-world point that is at a distance D1 from the UAV. Then, to compute the appropriate scale factor S1, the processor may apply an appropriate function “f(D),” such as a linear function that increases with increasing distance, to D1, i.e., the processor may compute the quantity f(D1). Assuming that the gesture has a magnitude (defined, for example, as the distance between the respective endpoints of the two complementary segments of the pinch gesture) M0, the processor may then compute the flying distance R1 for the maneuver as M0*f(D1)=M0*S1, and therefore cause the UAV to fly a distance of R1=M0*S1 toward the real-world point.

In a second case, a pinch-out gesture of identical magnitude M0 may be performed over a second portion of the image. The processor may first estimate that the second portion of the image represents a real-world point that is at a distance of only D2 from the UAV, D2 being less than D1. The lesser distance D2 implies that the user is requesting a zooming-in to a target of interest that is closer than the target of interest in the first case, and therefore, the user likely wants the flying distance of the UAV to be less than the flying distance in the first case, even though the magnitude M0 of the gesture is the same in both cases. Hence, the processor may, using the same function f(D) as in the first case, compute a scale factor f(D2)=S2 that is less than S1, and therefore cause the UAV to fly a distance of only R2=M0*S2.

Thus, R1 is a function of D1, while R2 is a function of D2. In other words, the distance traveled by the UAV is a function of the estimated distance from the UAV to the “target” of the gesture, i.e., the flying maneuver is scaled in accordance with the estimated distance to the point of interest. Embodiments of the present invention thus provide for more effective control of the UAV, and a more satisfying user experience.

In some embodiments, image-processing techniques are used to control the flight of the UAV. First, as described above, a gesture is received, and the processor of the mobile device, in response to the gesture, causes the UAV to begin executing the flying maneuver that is suggested by the gesture. Subsequently, as the processor receives subsequent images acquired by the UAV, the processor identifies the positions and/or one or more configurational properties of a plurality of features in these subsequent images. Upon the positions and/or configurational properties converging to a target, the processor ascertains that the desired change indicated by the gesture has been achieved, and therefore causes the UAV to terminate the flying maneuver.

For example, in response to a pinch-in gesture over a particular target, the processor may cause the UAV to fly away from the target. Subsequently, as the UAV flies, distances between features may begin to become progressively smaller. Hence, the processor may use the distances between the features to determine when the desired amount of zooming out has been achieved.

Alternatively or additionally, in some embodiments, the rate of change of the position of at least one identified feature in the acquired images is used to control the speed of the UAV. In particular, the processor first identifies a target rate of change, which is based on a desired maximum amount of change between successive images. The processor then compares the rate of change of the position of the feature with this target rate of change. If the rate of change differs from the target, the processor adjusts the speed of the UAV. In this manner, the UAV performs the flying maneuver at the maximum appropriate speed that can be attained without compromising the smooth flow of imagery in the acquired stream of images.

### System Description

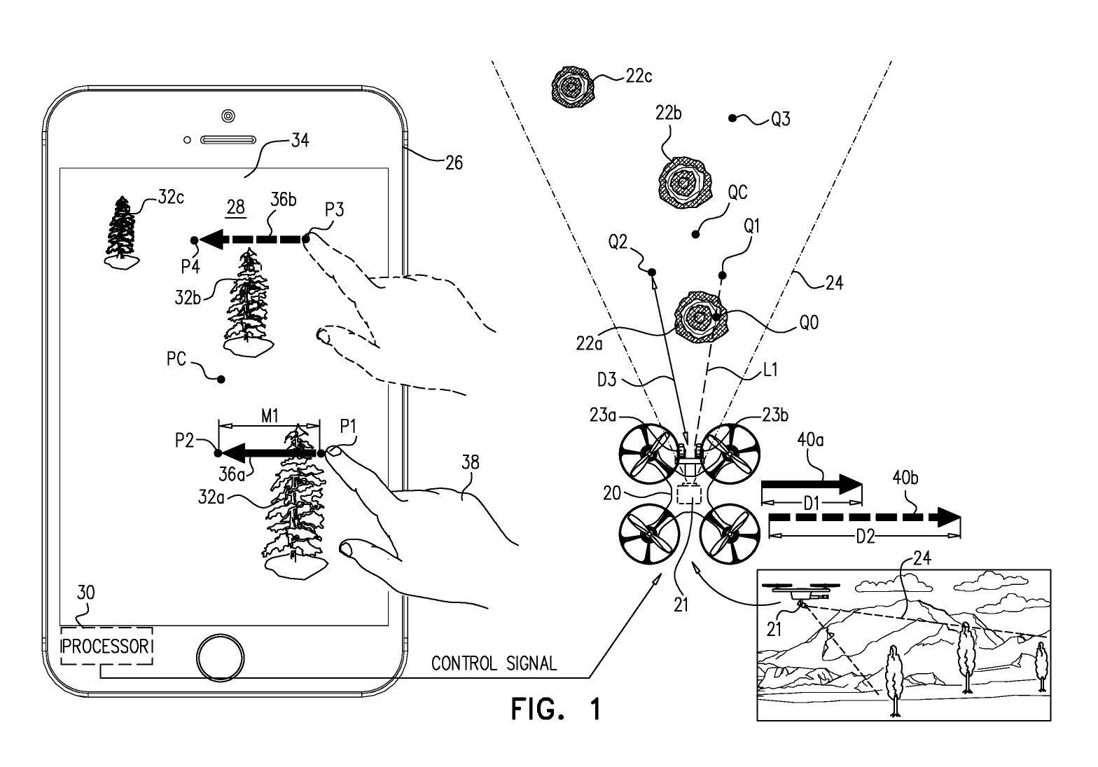

Reference is initially made to FIG. 1, which is a schematic illustration of a method for controlling a UAV 20 using a swipe gesture, in accordance with some embodiments of the present invention.

The right side of the figure shows an overhead view of UAV 20. UAV 20 may be configured, for example, as described in commonly-assigned U.S. patent application Ser. No. 14/936,699, filed Nov. 10, 2015, whose disclosure is incorporated herein by reference. As described in the '699 application, such a UAV comprises a payload imaging device for imaging targets, such as ground-based targets, and one or more additional imaging devices for obstacle detection. For example, in FIG. 1, UAV 20 is shown comprising a payload imaging device 21 on the underside of the UAV, and, in addition, two imaging devices 23a and 23b that may be used for obstacle detection. In general, techniques described in the present disclosure may be practiced in combination with the obstacle-avoidance techniques described in the '699 application.

Alternatively, embodiments described herein may be practiced with any other suitable UAV that includes at least one imaging device. (In general, unless specified otherwise, the term “imaging device,” as used throughout the present description, refers to payload imaging device 21.)

As the UAV flies along a flight path, imaging device 21 acquires images of the field-of-view (FOV) 24 of the imaging device. FOV 24 includes a plurality of objects 22a, 22b, and 22c, which are located at different respective distances from the UAV.

The left side of the figure shows a computing device 26, comprising, for example, a smartphone or tablet computer, which comprises a touch screen 34. Images acquired by the UAV imaging device are communicated wirelessly (directly, or via a server) to device 26, and touch screen 34 then displays the images. In the particular example shown in FIG. 1, each of objects 22a-c is represented in an image 28 that is displayed on the touch screen. In particular, object-representation 32a represents object 22a, object-representation 32b represents object 22b, and object-representation 32c represents object 22c. Due to the varying distances of the objects from the UAV, representations 32a-c are of varying sizes in image 28.

Gestures performed with respect to the images on touch screen 34 are received by a processor 30. In response to the gestures, processor 30 issues appropriate control signals to the UAV, as described in detail hereinbelow. For example, FIG. 1 shows a swipe gesture 36a being performed with respect to image 28. (To perform a swipe gesture, a user slides his finger 38 along the touch screen.) In response to swipe gesture 36a, processor 30 commands the UAV to perform a panning flying maneuver 40a, as described in further detail below.

In some embodiments, at least some of the tasks described herein may be performed by one or more other processors, alternatively or additionally to processor 30. For example, processor 30 may be cooperatively networked with an onboard processor residing on UAV 20, and/or one or more other processors residing “in the cloud” on remote servers, such that the processors cooperate in receiving and processing the gestures, and in controlling the UAV. In some embodiments, for example, processor 30 merely forwards the received gestures to the onboard processor and/or the remote processors, which process the gestures, and control the UAV in response thereto.

Processor 30, and/or any other relevant processor configured to perform any of the tasks described herein (e.g., an onboard processor on the UAV), is typically a programmed digital computing device comprising a central processing unit (CPU), random access memory (RAM), non-volatile secondary storage, such as a hard drive or CD ROM drive, network interfaces, and/or peripheral devices. Program code, including software programs, and/or data are loaded into the RAM for execution and processing by the CPU, and results are generated for display, output, transmittal, or storage, as is known in the art. The program code and/or data may be downloaded to the computer in electronic form, over a network, for example, or they may, alternatively or additionally, be provided and/or stored on non-transitory tangible media, such as magnetic, optical, or electronic memory. Such program code and/or data, when provided to the processor, produce a machine or special-purpose computer, configured to perform the tasks described herein.

As noted above, it is important that the flying maneuver be appropriately scaled. For example, gesture 36a runs from a starting position P1 to a finishing position P2 located to the left of P1; thus, in performing gesture 36a, the user is likely indicating that he would like a feature of interest currently appearing at position P1—in this case, the right edge of the top portion of object-representation 32a—to appear, in a subsequent image, at position P2. The UAV must therefore fly an appropriate distance D1 as indicated in the figure, in order to shift the feature of interest by a distance of |P2−P1| (which is equivalent to the magnitude M1 of the gesture). In other words, the distance of the flying maneuver 40a that is performed in response to the gesture must be appropriately scaled; otherwise, the feature of interest will not appear at position P2.

To scale the flying maneuver, the processor selects an appropriate portion of the image, estimates the distance from the UAV to the real-world point represented by the portion of the image, and then scales the flying maneuver by a scale factor that is based on the estimated distance. Typically, at least for a swipe gesture, the selected portion of the image lies along the path of the gesture, as it is assumed—as explained in the preceding paragraph with respect to gesture 36a—that the location on the screen at which the user performs the gesture indicates the desired scale of the flying maneuver.

For example, to scale the distance of flying maneuver 40a, the processor may select a pixel at position P2. The processor may then calculate, as further described below, the distance D3 to a real-world point Q2 that is assumed to be represented by the selected pixel, and may then compute a scale factor that is based on D3. The processor may then calculate the desired distance D1 of flying maneuver 40a, by multiplying the scale factor by magnitude M1 of swipe gesture 36a.

Alternatively to selecting the pixel at P2, the processor may select a pixel at position P1, or any other portion of the image that lies along the path of the gesture, such as a pixel at the center of the path of the gesture, i.e., midway between P1 and P2.

Due to image 28 having only two dimensions, the selected portion of the image may, in theory, represent an infinite number of real-world points. Therefore, the processor typically makes a simplifying assumption when estimating the distance to the real-world point represented by the selected portion of the image. In particular, the processor typically assumes that the point lies on the ground. In some embodiments, the ground is assumed to be (i.e., is modeled as) a horizontal plane beneath the UAV. In other embodiments, the processor uses a digital elevation model (DEM) to model the ground topology, and hence, uses the DEM to estimate the distance from the UAV to the given point.

For example, in theory, a pixel at position P1 may represent any one of an infinite number of points lying along the line L1. As it happens, the pixel, which is at the edge of the top portion of object-representation 32a, represents the corresponding real-world point Q0 that is shown in the figure. However, the processor assumes that the pixel represents the point at the intersection of line L1 with the ground—namely, the point Q1. As noted, to find this intersection, the processor either assumes that the ground is a flat, horizontal plane, or alternatively, uses a DEM to model the ground.

FIG. 1 also shows a hypothetical swipe gesture 36b that may be performed with respect to image 28. Hypothetical swipe gesture 36b and swipe gesture 36a have the same orientation, and also have identical magnitudes M1 (measured with reference to screen coordinates, e.g., in units of pixels). However, hypothetical swipe gesture 36b is performed at a different location on the screen from that of swipe gesture 36a, such that, in performing hypothetical swipe gesture 36b, the user is likely indicating that he would like the feature of interest currently appearing at position P3 (the starting position of the gesture) to appear, in a subsequent image, at position P4 (the finishing position of the gesture). To make this happen, the UAV must execute a hypothetical flying maneuver 40b whose distance D2 is greater than D1. Hence, to calculate D2, the processor may multiply M1 by a greater scale factor than that which was used to calculate D1. For example, the processor may use a scale factor that is based on the distance from the UAV to a point Q3, which is the assumed point corresponding to P3.

(Notwithstanding the above, in some embodiments, the processor uses the same scale factor, regardless of the position of the gesture. In such embodiments, the processor typically selects a portion of the image that is at a particular position, and then estimates the distance to the corresponding real-world point. For example, the processor may select a pixel at position PC, which is at the center of the image, and then calculate the distance to the corresponding point QC. The scale factor is then based on this calculated distance.)

The scale factor (which is typically in units of distance/pixel) is typically an increasing, linear function of the estimated distance to the real-world point, and is also typically a function of other variables, such as the size of the FOV and the screen resolution. For example, the scale factor may be computed by multiplying the estimated distance by a scalar coefficient α. Thus, for example, for a distance D3 of 100 meters, and assuming α=333 pixel⁻¹ (and ignoring any other variables, such as the size of the FOV), the scale factor would be 0.3 meters/pixel. Therefore, for a magnitude M1 of swipe gesture 36a of 200 pixels, the distance D1 of the flying maneuver would be 0.3*200=60 meters.

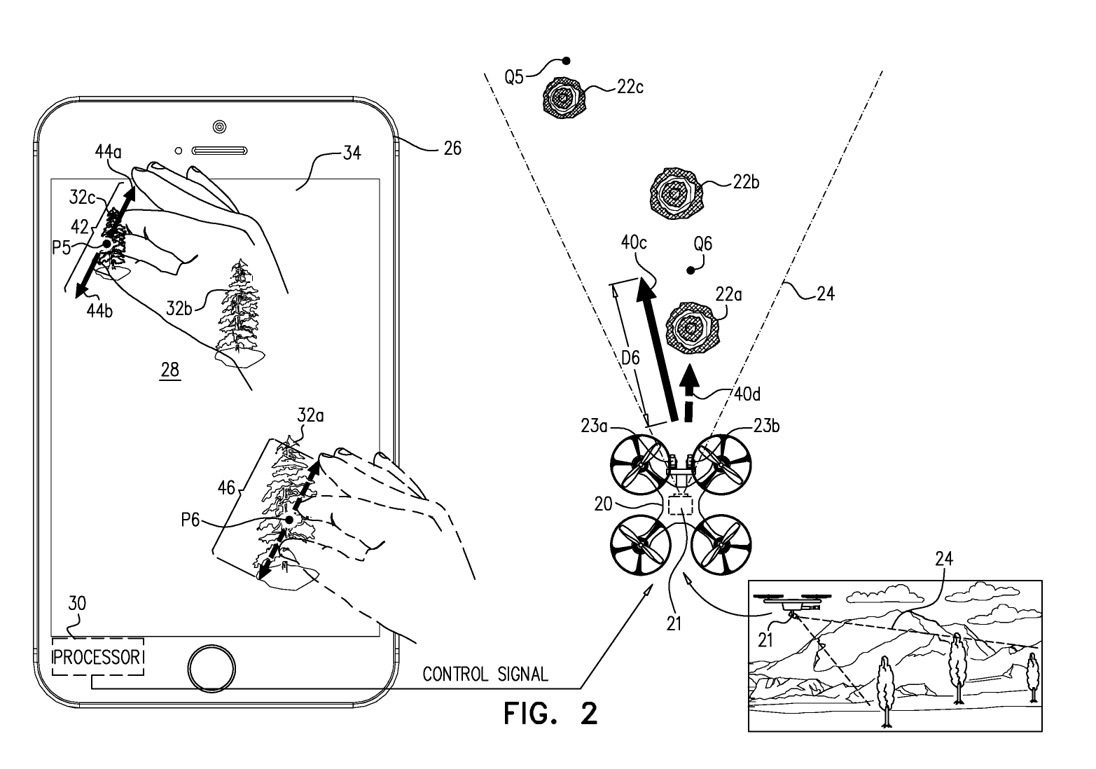

Reference is now made to FIG. 2, which is a schematic illustration of a method for controlling a UAV 20 using a pinch gesture, in accordance with some embodiments of the present invention.

FIG. 2 shows FOV 24, and image 28, exactly as shown in FIG. 1. In FIG. 2, however, the user is shown performing a pinch-out gesture 42, rather than a swipe gesture. Pinch-out gesture 42 includes two segments 44a and 44b, which are traced simultaneously on the screen. (In some cases, one of the segments may be significantly larger than the other. For example, the user may hold his thumb in a stationary position on the screen, while moving his forefinger along the screen, away from his thumb.) As noted above, by performing such a gesture, the user indicates that he would like to zoom in on a particular feature shown in the image.

In response to gesture 42, the processor selects an appropriate portion of the image, such as a pixel or group of pixels that lies between the two segments 44a and 44b. For example, the processor may select a pixel at position P5, which is centered between the respective starting positions of the segments. The processor then calculates the distance D5 (not explicitly indicated in the figure) from the UAV to point Q5, the ground point that is assumed to be represented by the pixel at P5, and further calculates the scale factor S5 (not explicitly indicated in the figure) from D5.

The processor also computes the magnitude M2 (not explicitly indicated in the figure) of pinch gesture 42. In some embodiments, the magnitude of a pinch gesture is computed as the distance between the respective endpoints of the two segments of the pinch gesture, such that the magnitude of pinch gesture 42 would be the distance between the respective endpoints of segments 44a and 44b. In other embodiments, the magnitude is calculated according to other suitable formulae.

The processor then calculates the distance D6 of the desired flying maneuver by multiplying S5 by M2. The processor then communicates a control signal to the UAV that causes the UAV to execute a flying maneuver 40c of distance (i.e., length) D6, toward point Q5.

FIG. 2 also shows a hypothetical gesture 46 performed at a different location on the screen. In response to gesture 46, the processor selects a different portion of the image, such as a pixel at position P6. Due to the corresponding real-world point Q6 being closer to the UAV than Q5, the computed scale factor for gesture 46 is less than S5, and hence, the UAV executes a flying maneuver 40d toward point Q6 that has a distance that is less than D6.

It is noted that, for pinch gestures, as for swipe gestures, any appropriate portion of the image may be selected for calculating the scale factor. For example, the processor may select a pixel that is centered between the respective start-points of the gesture segments, or any pixel that lies along one of the gesture segments. Each choice will result in a different outcome, and hence, user experience. In some embodiments, based on user feedback, the processor learns how to best choose the “target” point for calculating the scale factor.

It is noted that the scope of the present disclosure includes the use of any suitable technique for distance estimation, notwithstanding the particular examples described herein. For example, instead of using the flat-ground or DEM model, the processor may use any other suitable model to model the ground topology.

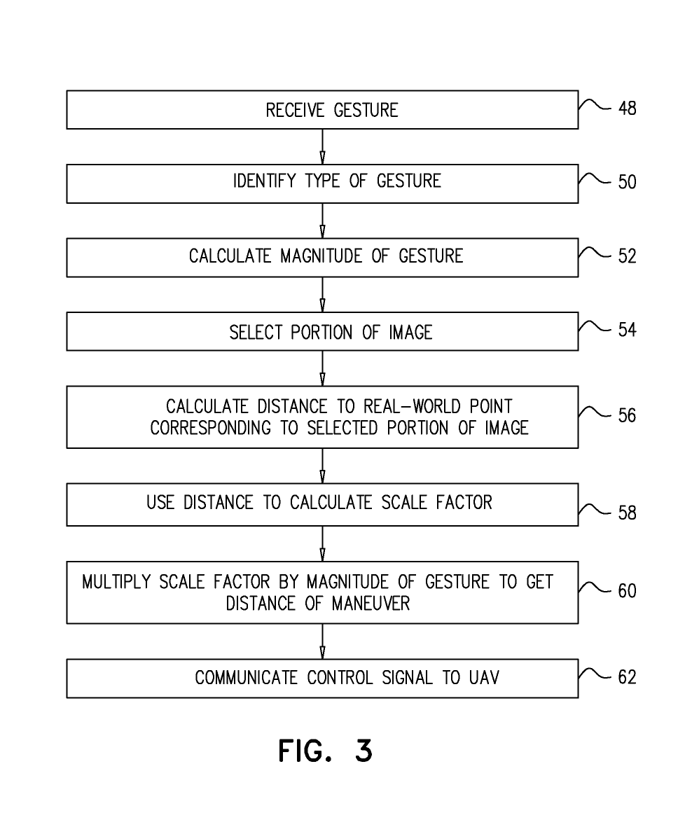

Reference is now made to FIG. 3, which is a flow diagram for a method for controlling a UAV, in accordance with some embodiments of the present invention. Most of the steps in the flow diagram were already described above, but are again, for further clarity, presented again with reference to FIG. 3.

First, at a receiving step 48, the processor receives a gesture that is performed with respect to an image displayed on the screen. The processor identifies the type of gesture at an identifying step 50, and further calculates the magnitude of the gesture at a magnitude-calculating step 52, this magnitude being expressed with respect to image coordinates, e.g., in units of pixels. For example, by performing steps 50 and 52, the processor may identify that the received gesture is a swipe gesture having a magnitude of 200 pixels.

Next, at a selecting step 54, the processor selects an appropriate portion of the image. For example, for a swipe gesture, the processor may select a pixel at the center of the swipe. At a distance-calculating step 56, the processor then calculates the distance to the real-world point corresponding to the selected portion of the image. (Effectively, the processor estimates the distance to the real-world point that is represented by the selected portion of the image, as described above.) In performing distance-calculating step 56, the processor typically assumes that the corresponding real-world point is on the ground, and uses a horizontal-plane model or a DEM to calculate the distance.

Next, at a scale-factor-calculating step 58, the processor uses the calculated distance to calculate the scale factor, expressed, for example, in units of meters/pixel. The scale factor is then multiplied by the magnitude of the gesture, at a multiplying step 60, to get the desired distance of the flying maneuver. Finally, at a communicating step 62, the processor communicates a control signal to the UAV, instructing the UAV to perform a flying maneuver that is of the type suggested by the gesture (e.g., a panning maneuver for a swipe gesture), and of the distance calculated in multiplying step 60.

Although the description above mainly relates to scaling the distance of a flying maneuver based on the magnitude of the gesture, it is noted that, alternatively, the speed of the flying maneuver may be scaled, based on the magnitude of the gesture. In such a case, the scale factor will typically have units of (distance/time)/pixel.

As yet another alternative, the distance or speed of the flying maneuver may be scaled, based on the speed (rather than the magnitude) of the gesture. Thus, for example, a gesture performed at a greater speed may yield a faster and/or distance-wise-longer flying maneuver, relative to a gesture performed at a lesser speed. For example, given a scale factor of 0.3 meters/(pixels/second), and a gesture speed of 200 pixels/second, the computed flying-maneuver distance would be 0.3*200=60 meters. As another example, given a scale factor of 0.03 meters/pixel, and a gesture speed of 200 pixels/second, the flying-maneuver speed would be 0.03*200=6 meters/second. For all of these alternatives, an appropriate function is used to compute the appropriate scale factor, based on the estimated distance to the point of interest.

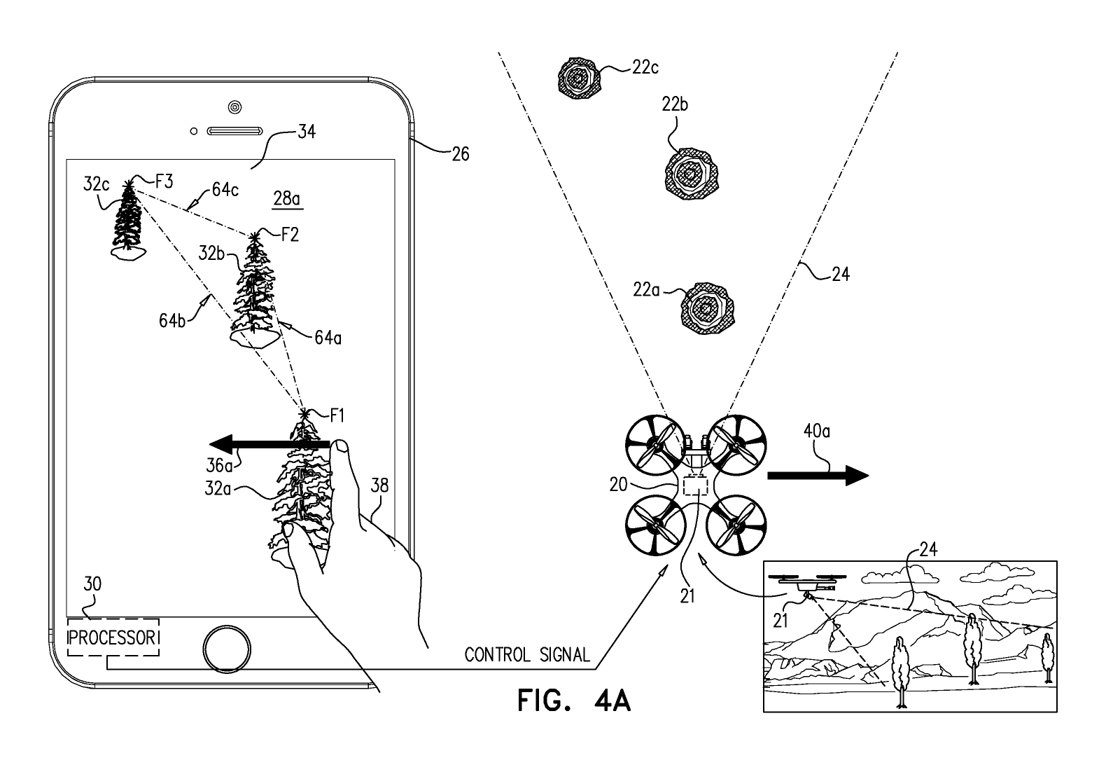

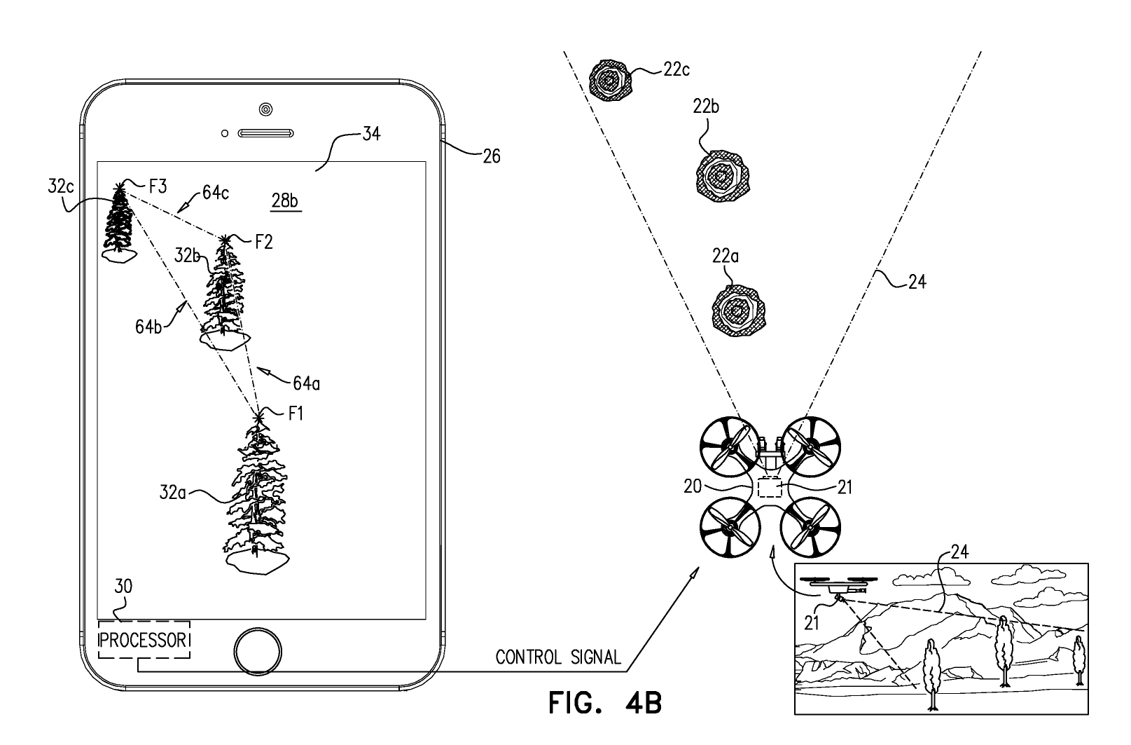

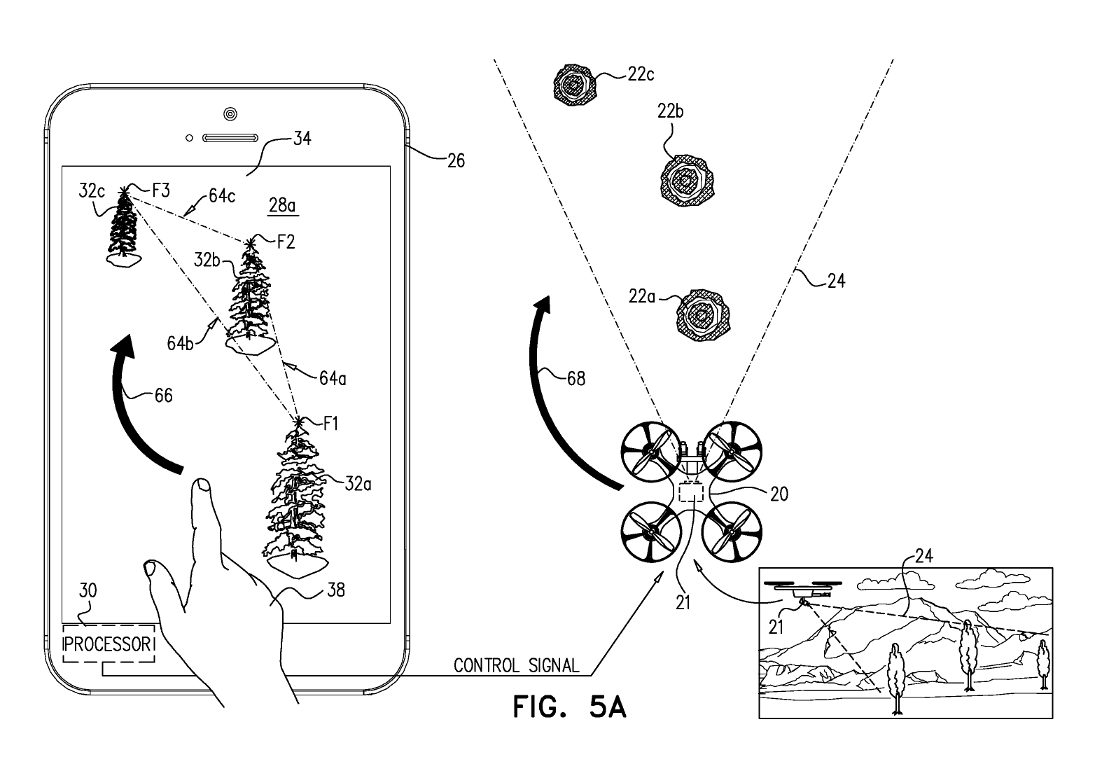

Reference is now made to FIGS. 4A-B, which are schematic illustrations of a method for controlling a UAV using a swipe gesture, in accordance with some embodiments of the present invention.

FIG. 4A again shows swipe gesture 36a, which was shown in, and described with reference to, FIG. 1. By performing swipe gesture 36a, the user indicates that he is requesting a particular change with respect to a first image 28a. In particular, the user indicates that he is requesting that the field of view of the UAV be shifted to the right, thus causing the scenery currently displayed in image 28a to be shifted to the left by the magnitude of the gesture.

As in FIG. 1, processor 30 receives the gesture, and in response thereto, communicates a control signal that causes the UAV to begin executing a flying maneuver that is suggested by the gesture. For example, in response to receiving swipe gesture 36a, the processor instructs the UAV to begin performing a panning flying maneuver 40a, as described above.

In the case of FIG. 4A, however, the processor does not necessarily a priori compute the scale of the flying maneuver. Rather, as the UAV flies, the processor uses image-processing techniques to monitor the progress of the flying maneuver. Upon ascertaining, using the image-processing techniques, that the requested change has been effected, the processor communicates a second control signal that causes the UAV to stop flying.

(Notwithstanding the above, it is noted that embodiments described with respect to FIG. 4A and subsequent figures may, in certain cases, be combined with embodiments described with respect to earlier figures. For example, an initial flying speed of the UAV may be set using the “scale factor” technique described above, and subsequently, the image-processing techniques described hereinbelow may be used to adjust the speed as appropriate, and/or to determine when to stop the UAV.)

Specifically, to monitor the progress of the flying maneuver, the processor first identifies a plurality of features in image 28a. For example, FIG. 4A shows three such features F1, F2, and F3. Example techniques for feature identification include the scale-invariant feature transform (SIFT) and the Speeded-Up Robust Features (SURF) technique. Typically, the processor then computes one or more target positions (i.e., screen coordinates) of the features, and/or a target configurational property of the features (i.e., a property that relates to positions of the features with respect to each other), based on the gesture. As the UAV begins to move, and subsequent images are acquired by the imaging device, the processor identifies the respective positions of the same features in the subsequent images, and, if relevant, computes the configurational property. Upon convergence of the positions and/or configurational property to the target(s), the processor ascertains that the flying maneuver has effected the requested change. Subsequently, in response to the ascertaining, as shown in FIG. 4B, the processor communicates, to the UAV, another control signal that causes the UAV to stop execution of the flying maneuver.

Examples of potentially relevant configurational properties of the features include:

(i) the screen coordinates of a center of mass of the features;

(ii) the magnitudes of the vectors that connect the features to each other (i.e., the distances of the features from each other in the image); and

(iii) the orientations of the vectors that connect the features to each other.

For example, FIGS. 4A-B show a vector 64a that passes between F1 and F2, a vector 64b that passes between F1 and F3, and a vector 64c that passes between F2 to F3. (Such vectors are typically represented only internally by the processor, i.e., they are not displayed. Vectors 64a-c are shown in the present figures for sake of illustration only.) Upon receiving each subsequent image that follows the first image, the processor may identify the positions of F1, F2, and F3, and may further compute the respective magnitudes of, and/or orientations of, vectors 64a-c. These quantities may then be compared to respective targets.

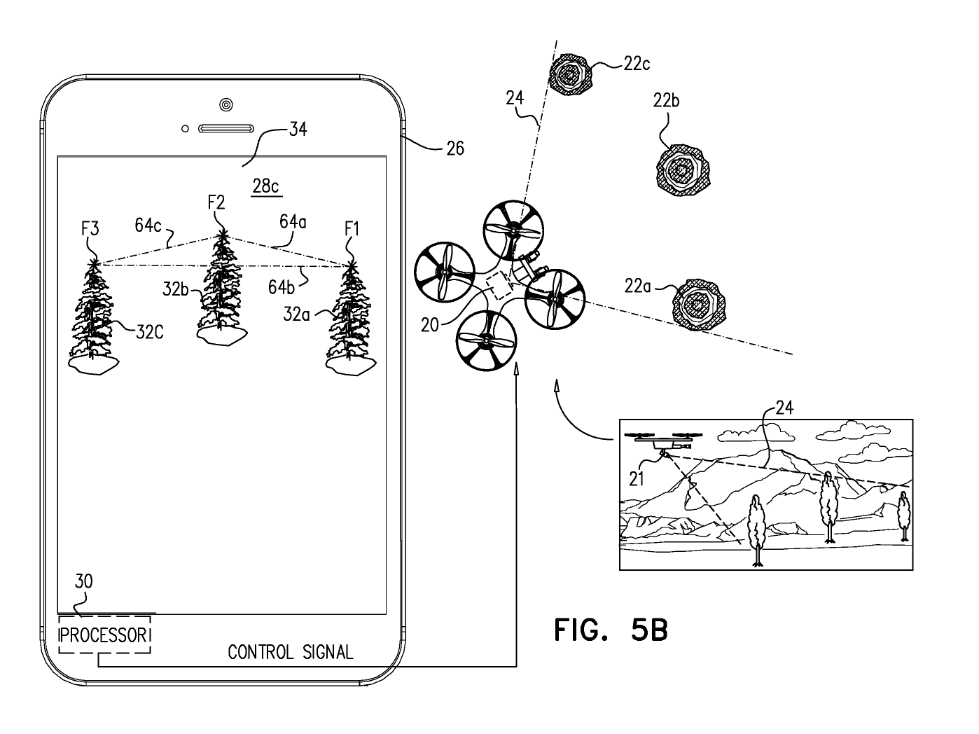

To calculate the target positions (in screen coordinates) and/or configurations, the processor may use any suitable method. Two such methods are described below with reference to FIG. 4A, and another method is described below with reference to FIG. 5A.

(i) The processor may compute separate target screen-coordinates for each of the features. For example, assuming that swipe gesture 36a has a magnitude of 500 pixels, and given the proximity of feature F1 to the starting point of the swipe, the processor may first assign a target position for feature F1 that is 500 pixels to the left of the current position of F1. For features F2 and F3, which are farther from the starting point of the swipe, the processor may assign respective target positions as follows:
(a) The processor may estimate (e.g., using a flat-ground or DEM model) the distances from the UAV to the real-world points represented by features F1, F2, and F3, and then compute the respective target positions for F2 and F3 based on these real-world distances. For example, the processor may estimate that the real-world correspondent to feature F2 is X meters from the UAV, while the real-world correspondent to feature F1 is only Y meters from the UAV. Hence, given the relationship between X and Y, the processor may assign a target movement to F2 that is less than 500 pixels (e.g., only 250 pixels). Given the even greater estimated real-world distance of feature F3, the target movement for F3 may be even less (e.g., only 100 pixels).
(b) The processor may instruct the UAV to begin the maneuver, and then evaluate the relative velocities of the features on the screen. Thus, for example, F1 may be seen to move to the left by 10 pixels per frame, F2 may be seen to move to the left by 5 pixels per frame, and F3 may be seen to move to the left by 2 pixels per frame. In response thereto, the processor may assign a target position for F2 that is 250 pixels to the left of the current position of F2 (5/10*500=250), and a target position for F3 that is 100 pixels to the left of the current position of F3 (2/10*500=100).

(ii) The processor may compute the center of mass of several features that are near the starting point of the gesture, and set a target movement for the center of mass that corresponds to the magnitude of the gesture. For example, the processor may compute the center of mass of F1 and several other features (not shown in the figure) that are near the starting point of gesture 36a. Assuming that swipe gesture 36a has a magnitude of 500 pixels, the processor may assign a target position for this center of mass that is 500 pixels to the left of the current position of the center of mass.

Typically, the processor defines a suitable distance function, which is used for evaluating convergence to the target. As a simple example, assuming method (ii) as described above, the distance function may be the absolute difference between (i) the current center-of-mass of the features, and (ii) the target center-of-mass of the features. Alternatively, for example, the distance function may compute a scalar or vector value that quantifies the difference between the current positions and/or configurational properties of the features, and the initial positions and/or configurational properties of the features. In any case, by applying the distance function to each image, the processor tracks progress of the flying maneuver, one image at a time, until the processor ascertains that the flying maneuver has effected the requested change. In some embodiments, to reduce the effects of noise and other factors that may inhibit proper identification of the features, the processor averages the output of the distance function over several images.

If any of the features stops appearing (e.g., due to an occlusion in FOV 24, or due to the feature having moved outside the FOV), the processor may identify a replacement feature. The processor may then use the replacement feature, in combination with the remaining features, to track progress of the flying maneuver. Alternatively or additionally, for greater confidence, the processor may identify and use new features, even if all of the original features continue to appear in the acquired images.

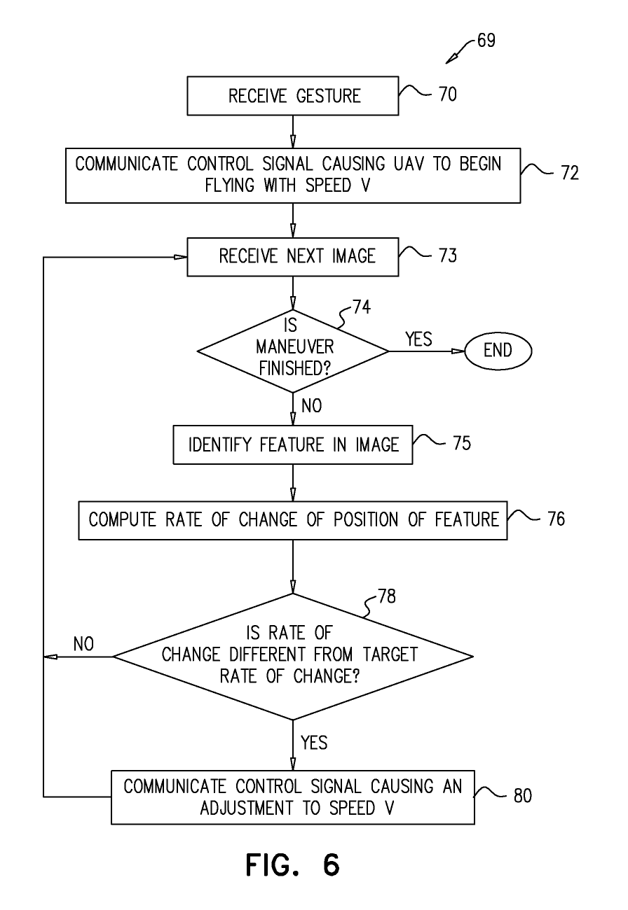

In response to tracking the progress of the flying maneuver as described above, the processor may also communicate interim control signals to the UAV that change the execution of the flying maneuver. For example, the processor may communicate a control signal that causes the UAV to change the path of the flying maneuver, and/or change the speed of the flying maneuver, as further described below with reference to FIG. 6.

Techniques described above with reference to FIGS. 4A-B may also be practiced for other types of gestures, such as a pinch gesture or rotation gesture. For example, reference is now made to FIGS. 5A-B, which are schematic illustrations of a method for controlling a UAV using a rotation gesture, in accordance with some embodiments of the present invention. To perform a rotation gesture, the user traces an arc 66 along touch screen 34. Such a gesture suggests the performance of a rotation maneuver 68 having a magnitude (expressed in degrees, or radians, of rotation) that is equal to that of arc 66, in the clockwise direction of the gesture. Thus, the processor communicates a first control signal to the UAV, causing the UAV to begin executing rotation maneuver 68. The processor then uses the techniques described above to track progress of the rotation maneuver. Upon ascertaining, based on image 28c shown in FIG. 5B, that the UAV has moved in accordance with the gesture, the processor communicates a subsequent control signal that stops the UAV.

As described above, any suitable configurational properties of the features may be used to ascertain that the desired rotation maneuver has been completed. For example, the processor may compute the orientations of the vectors that connect the features to each other, given that, generally speaking, a rotation maneuver changes these orientations (without changing the lengths of the vectors, assuming the center of rotation remains constant). Thus, for example, the processor may determine, based on the magnitude of arc 66 and the initial orientation of vector 64b, that the target orientation of vector 64b is a completely horizontal orientation, i.e., at completion of the flying maneuver, vector 64b should define an angle of zero degrees with respect to the horizontal axis of the image. The processor may therefore use a distance function that returns the current angle of vector 64b. Upon the distance function returning a value of zero (for image 28c), the UAV is stopped.

Reference is now made to FIG. 6, which is a flow diagram for a method 69 for controlling the speed of a UAV, in accordance with some embodiments of the present invention. Method 69 may be performed in combination with both the scale-factor-based and image-processing-based embodiments described above.

First, at a gesture-receiving step 70, the processor receives a gesture that is performed with respect to a first image acquired by the imaging device. Such a gesture may include, for example, a swipe, pinch, or rotation gesture. Subsequently, at a first communicating step 72, the processor communicates, to the UAV, a control signal that causes the UAV to begin executing the flying maneuver indicated by the gesture, at a speed V. The speed V is typically the maximum appropriate speed that can be attained without causing an undesirable amount of change between adjacent frames. (In this context, “appropriate” means not greater than the maximum speed that the UAV can fly or than a flying speed that was requested by the user.) For example, the processor may assume that the user does not want to see a change of more than 1%-2% from one image to the next, and hence, may set V to the speed that is estimated to yield such a change.

Subsequently, at a receiving step 73, the processor receives a subsequent image from the UAV. First, at a checking step 74, the processor checks whether the flying maneuver is finished. For example, for embodiments in which image processing is used to track and manage the flying maneuver, the processor may check the positions of the identified features in the most recently received image, as described above with reference to FIGS. 4A-B and 5A-B. If yes, the flying maneuver ends. Otherwise, at a feature-identifying step 75, the processor identifies, in the most recently received image, a feature that was identified in a previous image. For example, the processor may use the SIFT or SURF technique to identify the feature.

Next, at a computing step 76, the processor computes a rate of change of the position of the feature. Then, at a comparison step 78, the processor compares the rate of change to a target rate of change. Such a target rate of change may be based on assumed user preferences, as described above. If the rate of change differs from the target, the processor, at a second communicating step 80, communicates a control signal to the UAV that causes an adjustment to V. (In other words, the control signal causes the UAV to continue executing the flying maneuver at a speed that is different from the speed at which the UAV was previously flying.)

For example, assuming that the resolution of screen 34 is 1000 pixels in height, the target rate of change might be 1.5% of 1000 pixels, namely, 15 pixels. Hence, if the processor, at computing step 76, determines that the position of the feature is changing by more than 15 pixels per frame, the processor may decrease the speed of the UAV accordingly. Conversely, if the position of the feature is changing by less than 15 pixels per frame, the processor may increase the speed of the UAV accordingly.

In computing the rate of change of the position of the feature, the processor typically averages over several frames, to reduce the effect of noise or other sources of inaccuracy in identifying the feature.

As the UAV continues along the flying maneuver, the processor continues to receive the latest images at receiving step 73, and repeats the above-described sequence of steps with reference to each of these images.

For embodiments in which the processor, in any case, identifies a plurality of features in each image, one of these plurality of features may be used for computing step 76 and comparison step 78. For example, feature F1, F2, or F3 (FIGS. 4A-B and 5A-B) may be used for these steps.

In general, it is noted that the embodiments described herein may be practiced with any suitable types of gestures, and with any suitable conventions with respect to interpretation of the gestures. For example, although the present disclosure relates to a leftward swipe gesture (as shown in FIG. 1, for example) as indicating an instruction to fly rightward, the opposite interpretation is also possible, i.e., a leftward swipe may indicate an instruction to fly leftward. Per the former interpretation of the gesture, the gesture directly indicates the requested change to the image, in that the user indicates that he would like the imagery in the image to move leftward. Per the latter interpretation, the gesture also indicates—albeit, less directly—the requested change to the image, in that, by requesting a leftward flying maneuver, the user indicates that he would like the imagery to move rightward. (Hence, it follows that phraseology herein, including in the claims, such as “wherein the gesture indicates a requested change with respect to the first image,” should not be construed as being limited to any one particular gesture-interpretation convention.)

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus for operating an unmanned aerial vehicle (UAV) that includes an imaging device, the apparatus comprising:
a touch screen; and
a processor, configured to:
receive a gesture that is performed on the touch screen with respect to an image captured by the imaging device,
estimate a distance from the UAV to a given point represented in the image,
compute a scale factor that is based on the estimated distance, and
communicate a control signal that causes the UAV to execute a flying maneuver that is suggested by the gesture and is scaled by the scale factor.

2. The apparatus according to claim 1, wherein the image is a first image, wherein the gesture indicates a requested change with respect to the first image, and wherein the flying maneuver is suggested by the gesture in that, while executing the flying maneuver, subsequent images captured by the imaging device become successively more exhibitory of the requested change, relative to the first image.

3. The apparatus according to claim 1, wherein the scale factor is an increasing function of the estimated distance.

4. The apparatus according to claim 1, wherein the gesture is a swipe gesture.

5. The apparatus according to claim 1, wherein the gesture is a pinch gesture.

6. The apparatus according to claim 5, wherein the given point is represented by a portion of the image that lies between two segments of the pinch gesture.

7. The apparatus according to claim 1, wherein the processor is configured to estimate the distance by assuming that the given point lies on ground.

8. The apparatus according to claim 7, wherein the processor is configured to model the ground as a horizontal plane.

9. The apparatus according to claim 7, wherein the processor is configured to model the ground using a digital elevation model.

10. The apparatus according to claim 1, wherein the given point is represented by a portion of the image that lies along a path of the gesture.

11. The apparatus according to claim 1, wherein the processor is configured to scale the flying maneuver by multiplying a magnitude of the gesture by the scale factor.

12. The apparatus according to claim 1, wherein the processor is configured to scale the flying maneuver by multiplying a speed of the gesture by the scale factor.

13. The apparatus according to claim 1, wherein a distance of the flying maneuver is scaled by the scale factor.

14. The apparatus according to claim 1, wherein a speed of the flying maneuver is scaled by the scale factor.

15. A method for operating an unmanned aerial vehicle (UAV) that includes an imaging device, the method comprising:
receiving a gesture that is performed with respect to an image captured by the imaging device;
estimating a distance from the UAV to a given point represented in the image;
computing a scale factor that is based on the estimated distance; and
communicating a control signal that causes the UAV to execute a flying maneuver that is suggested by the gesture and is scaled by the scale factor.

16. The method according to claim 15, wherein the image is a first image, wherein the gesture indicates a requested change with respect to the first image, and wherein the flying maneuver is suggested by the gesture in that, while executing the flying maneuver, subsequent images captured by the imaging device become successively more exhibitory of the requested change, relative to the first image.

17. The method according to claim 15, wherein the scale factor is an increasing function of the estimated distance.

18. The method according to claim 15, wherein the gesture is a swipe gesture.

19. The method according to claim 15, wherein the gesture is a pinch gesture.

20. The method according to claim 19, wherein the given point is represented by a portion of the image that lies between two segments of the pinch gesture.

21. The method according to claim 15, wherein estimating the distance comprises estimating the distance by assuming that the given point lies on ground.

22. The method according to claim 21, wherein the ground is modeled as a horizontal plane.

23. The method according to claim 21, wherein the ground is modeled using a digital elevation model.

24. The method according to claim 15, wherein the given point is represented by a portion of the image that lies along a path of the gesture.

25. The method according to claim 15, wherein the flying maneuver is scaled by multiplying a magnitude of the gesture by the scale factor.

26. The method according to claim 15, wherein the flying maneuver is scaled by multiplying a speed of the gesture by the scale factor.

27. The method according to claim 15, wherein a distance of the flying maneuver is scaled by the scale factor.

28. The method according to claim 15, wherein a speed of the flying maneuver is scaled by the scale factor.
